(19) United States
(12) Patent Application Publication
(10) Pub. No.: US 2025/0128915 A1
(43) Pub. Date: Apr. 24, 2025

(54) DOOR SYSTEM FOR AN ELEVATOR SYSTEM

(71) Applicant: Inventio AG, Hergiswil (CH)

(72) Inventors: Antonio Perfetto, Ebikon (CH); Valerio Villa, Colverde (IT)

(21) Appl. No.: 18/719,280

(22) PCT Filed: Dec. 2, 2022
(86) PCT No.: PCT/EP2022/084150

§ 371 Date: Jun. 13, 2024

(30) Foreign Application Priority Data
Dec. 20, 2021 (EP) 21215810.9

(51) Int. Cl. B66B 13/26; B66B 3/00; B66B 13/14

(52) U.S. Cl. CPC B66B 13/26; B66B 3/002; B66B 13/143

(57) ABSTRACT

A door system for an elevator system includes: a door frame framing a door opening and having a door jamb; and a monitoring unit mounted on the door frame and monitoring a region of the door opening. A region of the door frame has a retroreflective surface that extends over at least 20% of a height of the door jamb. The monitoring unit has a light source that illuminates the retroreflective surface with light beams and a light sensor that measures the angle-resolved intensity of the light beams reflected by the retroreflective surface. The monitoring unit determines an output value based upon the angle-resolved intensity and detects when the angle-resolved intensity falls below a threshold intensity for at least one angle. The output value includes whether there is an obstacle in the monitored region.

### FIELD

The present invention relates to a door system for an elevator system.

### BACKGROUND

In an elevator system, a car is typically moved vertically along a travel path between different floors or levels within an elevator shaft. For this purpose, the door system has floor doors, and the car has at least one car door on the individual floors. The car door and/or the floor doors have a drive. In order for persons or goods to be able to enter or exit the car on a floor, one of the floor doors and the car door can be opened together. In order to be able to securely close the floor door and the car door, the door systems have a monitoring unit which serves to detect obstacles in the region of the doors, i.e., the assembly consisting of the floor door and the car door, and, in the event of a detected obstacle, the closing of the doors is reversed, prevented, decelerated, and/or slowed down.

The application EP 2931644 A1 (see WO 2014/147292 A1) discloses a light curtain. A plurality of transmitters that emit a light and a plurality of receivers that receive the light form a system of light beams whose interruption, e.g. by an obstacle, is detected. For this purpose, a large number of transmitters and receivers are wired. This can be very complex.

U.S. Pat. No. 6,167,991 B1, GB 2 453 804 A, and U.S. Pat. No. 4,029,176 A disclose monitoring systems in the door area with a plurality of transmitters and receivers.

### SUMMARY

An object of the invention can therefore be considered of providing a monitoring unit for a door system that is to be wired with less complexity.

The door system according to the invention achieves the object. The door system for an elevator system comprises a door frame which frames a door opening and comprises a first door jamb. The door system also comprises a first monitoring unit, which is mounted on the door frame, for monitoring a monitoring region of the door opening. At least one first region of the door frame has a first retroreflective surface. The first monitoring unit has a light source which is designed to illuminate the first retroreflective surface with light beams. The first monitoring unit comprises a light sensor which is designed to measure the angle-resolved intensity of the light beams reflected by the retroreflective surface. The first monitoring unit determines an output value based upon the angle-resolved intensity in that the first monitoring unit monitors when the angle-resolved intensity falls below a threshold intensity for at least one angle or angular range. The output value includes whether the angle-resolved intensity lies below the threshold intensity for at least one of the angles or one of the angular ranges.

Possible features and advantages of embodiments of the invention can be regarded, inter alia and without limiting the invention, as being based upon the concepts and findings described below.

A retroreflective surface reflects back an incident light beam substantially in the direction from which the light beam strikes the retroreflective surface. The light beam is typically slightly fanned out. A single light beam would therefore be widened to a beam cone with an opening angle during reflection. An opening angle can therefore be 1°, for example.

As already mentioned in the introduction, conventional door systems have a large number of light-emitting transmitters and light-receiving receivers. Preferably, the first monitoring unit has only a single light source. The light of the light source can be emitted as a light beam fan so that at least the first retroreflective surface is illuminated. It is advantageous to bundle the light of the light source onto the retroreflective surface. The light of the light source can alternatively radiate wider, i.e., also in directions other than only the retroreflective surface. However, the retroreflective surface can also be continued adjacent to the first region. Those light beams come back to the first monitoring unit which are reflected back by the retroreflective surface. The light beams are measured in the first monitoring unit by the light sensor. The light sensor is designed such that it can determine the intensity of the light reflected by the retroreflective surface with angular resolution. For this purpose, the light sensor can be designed as a line sensor. The light sensor comprises a series of sensor elements. The light is bundled onto the sensor elements by an optical system. The light from a specific angle, i.e., from a specific location on the retroreflective surface, is thereby bundled onto an individual sensor element. The individual measured values of the individual sensor elements can then be combined to form the angle-resolved intensity.

Alternatively, however, an angle-resolved intensity can also be determined in that the light source can pivot the light in the form of a narrow light beam, i.e., for example, a laser beam, along the retroreflective surface. The light beam is so narrow that an obstacle to be detected is larger than the width of the light beam. This indicates the advantage that only a single sensor element is required to measure the intensity of the light reflected by the retroreflective surface in the light sensor. In this case, the optical system is designed to bundle the light from all directions of the monitoring region onto the individual sensor element. The angle-resolved intensity can then be determined in that the angle of the pivoted narrow light source that changes over time is correlated with the intensity measured by the sensor element at the corresponding time.

As long as no obstacle is located in the beam path, i.e., for the path of a light beam from the light source over the retroreflective surface up to the light sensor, the angle-resolved intensity of the reflected light is above the threshold intensity for all angles. If an obstacle penetrates into the monitoring region, the obstacle prevents the light from the light source from reaching the retroreflective surface, because it is scattered or absorbed in other directions by the obstacle. As a result, the scattered or absorbed light beam cannot be reflected back to the first monitoring unit. The intensity of the light beam measured by the sensor element, which strikes the light sensor from an angle in which the obstacle lies, decreases. As a result, the angle-resolved intensity of the reflected light for the angle in which the obstacle is located falls below the threshold intensity. As a result, the first monitoring unit can at least determine that an obstacle is located in the monitoring region, i.e., in the region of one of the beam paths.

It can be advantageous to arrange or align the sensor elements in such a way that an identical angle is spanned between angles measured by the sensor elements. This results in uniform monitoring of the monitoring region. As a result, obstacles which are at the same distance to the first monitoring unit and are of the same size can be recognized similarly well, regardless of the angle. In particular, due to the uniform angular distance, it is easier to calculate back to the angle associated with a specific sensor element of the light sensor.

The first monitoring unit preferably determines the output value based upon the angle-resolved intensity in that the first monitoring unit detects when the angle-resolved intensity falls below a threshold intensity for at least seven-preferably adjacent-angles. In other words, falling below the angle-resolved intensity is therefore determined in seven, preferably adjacent sensor elements. As a result, the first monitoring unit is more robust with respect to smaller interfering obstacles such as dust or lint, for example.

According to a preferred embodiment, the height of the first region of the door frame extends over at least 20% of the height of the door opening.

A significant region of the door opening can thereby be monitored. The retroreflective surface preferably runs over the entire height of the door opening. As a result, an even larger monitoring region can be monitored by a first monitoring unit. In addition, a continuous retroreflective surface is less conspicuous to the human eye than an interrupted one.

According to a preferred embodiment, the light source is designed to emit infrared light, the retroreflective surface is designed to reflect the infrared light, and the light sensor is designed to measure the angle-resolved intensity of the infrared light.

The utilized light is limited to an infrared light spectrum. The retroreflective surface is designed such that it can reflect the infrared light retroreflectively. The light sensor is also preferably designed such that it can measure in particular the infrared light. Therefore, primarily only the angle-resolved intensity of the infrared light is measured, and in particular other light sources that do not serve the function of the first monitoring unit do not have any effect or only have a slight effect on the measurement of the angle-resolved intensity.

The infrared light is not seen by humans. As a result, the light source, and therefore the first monitoring unit, remains inconspicuous to the human eye. In particular, the retroreflective surface can have any color for the human eye. In particular, the retroreflective surface can also appear black or gray to the human eye, even though it is retroreflective for infrared light. This allows a free color selection for the door frame.

In addition, the evaluation by the first monitoring unit is also disturbed less by other light sources, since typically no strong infrared light sources are attached or present in or near elevators.

According to a preferred embodiment, the light source is designed to emit light which is amplitude-modulated at a frequency, the first monitoring unit has an evaluation unit which is designed to demodulate the angle-resolved intensities, and the first monitoring unit is designed to determine the output value based upon the demodulated, angle-resolved intensities.

In the case of light which is amplitude-modulated, the intensity of the emitted light fluctuates at a certain frequency. Such a frequency can be in a range between 100 and 100,000 Hz, for example. A preferred value can be 500 to 1,000 Hz. The advantage of the modulation is that the first monitoring unit determines the output value in a robust manner. In particular, disturbances by other light sources are prevented. The probability that an interfering light source is modulated at the same frequency is extremely low. In particular if the light source is also designed to emit infrared light, the probability drops even further that another light source can interfere with the first monitoring unit. This leads to reliable operation of the first monitoring unit and therefore contributes to safe operation of the elevator system.

According to a preferred embodiment, the retroreflective surface is applied as a spray layer, coating, or as retrotape.

Retrotape is a thin strip-preferably made of plastic-which has a retroreflective surface. The retrotape can be glued on. It can be designed to be self-adhesive. The retroreflective surface can also be applied by spraying or painting. For this purpose, retroreflective particles are preferably dissolved together with a binder in a solvent so that a paintable or sprayable emulsion is produced. The application of the retroreflective surface onto the door frame as a spray layer, paint, or as retrotape allows the retroreflective surface to only be thin. A thin retroreflective surface allows the passengers or goods to pass unhindered through the door opening. In addition, however, it can also be easy to repair if it should be rubbed off, for example, by using the elevator. The retroreflective surface can simply be taped over or painted over without the old retroreflective surface necessarily having to be removed. It is also advantageous to attach the retroreflective surface in a recess on the door frame, which makes it at least partially protected from scratching.

According to a preferred embodiment, the first monitoring unit is embedded in the door frame.

As a result, the passage through the door opening is completely free, because no protruding elements are installed in the door frame. Embedded in the door frame, the monitoring device is protected against shocks. In particular, the monitoring device does not protrude from the door frame and is therefore protected from being knocked and damaged by goods, such as pallets, or people, such as by people's shoes.

The surface of the sensor preferably forms a continuous surface with the surface of the door frame. That is to say, the surface of the door frame extends substantially flat up to the first monitoring unit. For this purpose, the first monitoring unit is adapted to the color and structure of the door frame. If a cover layer of the door frame is transparent to the light used, this layer can run over the first monitoring unit. In both variants, the monitoring sensor is inconspicuous in appearance.

According to a preferred embodiment, the first monitoring unit is mounted on the door frame of the car door.

The first monitoring unit is mounted on the door frame of the car, i.e., on the car. The number of cars in an elevator system is typically much lower than the number of approachable floors. Otherwise, the approachable floors would all have to have a first monitoring unit. The use of the first monitoring unit on the car therefore has the advantage that many fewer of the monitoring units have to be used. In addition, the monitoring device on the car is easier to connect to the electrical power supply and/or to an electronic data line than is possible from a floor, since the car has a plurality of power cables and/or data cables to the elevator controller. The floor doors are often connected to the elevator controller only via the safety circuit. However, the safety circuit is not or only poorly suited for power supply or as a data line.

It can be advantageous to simultaneously attach monitoring units to the door frame of the car and to the door frame on the floors in order to achieve particularly reliable monitoring.

According to a preferred embodiment, a second monitoring unit is mounted on the door frame.

According to a preferred embodiment, a third monitoring unit is mounted on the door frame.

By using a second monitoring sensor and optionally a third monitoring sensor, it is possible to monitor a larger region of the door opening than would be possible with just one sensor.

According to a preferred embodiment, the first monitoring region of the first monitoring unit overlaps with a second monitoring region of the second monitoring unit.

According to a preferred embodiment, the second monitoring region of the second monitoring unit overlaps with a third monitoring region of the third monitoring unit.

Overlapping monitoring regions allow the monitoring units to be mounted with a greater tolerance. The monitoring regions of the door opening which overlap are monitored by at least two monitoring devices. Even if one of these monitoring devices is easily misaligned, the overlapping monitoring region is still reliably monitored. This means that there are reliably no gaps between the monitoring regions. This results in the advantage that the entire door opening can be monitored without gaps.

The second and the third monitoring units can be of the same design as the first monitoring unit. As a result, more monitoring units of this one type are produced, which reduces the unit costs. There is also no risk of any confusion, which could exist if the first, second, and third monitoring devices were of different designs.

According to a first alternative embodiment, a first monitoring unit is mounted on a lower end of a first door jamb oriented in such a way as to allow a light beam to pass horizontally above the door sill, and a further-preferably the second-monitoring unit is mounted on an upper end of the first door jamb or preferably of the opposite, second door jamb.

The door opening is bordered at the bottom by a horizontal door sill and at the top by a horizontal door lintel. Advantageously, the retroreflective surface is mounted only on the door jambs, because it is less exposed to abrasion and damage than it would be on the door sill. The door lintel is often not suitable for attaching a retroreflective surface. There are often cut-outs in the door lintel that allow the doors to be moved. Lamps can be mounted which illuminate the door sill so that the passengers can easily recognize the door sill.

The obstacles often lie directly on the door sill. It is therefore advantageous that the first monitoring unit is designed to measure at least one light beam whose beam path extends horizontally-preferably only a few millimeters above the door sill. Preferably, the beam path runs less than 20 mm above the door sill in order to also be able to detect thin objects, such as a foot tip, for example. Preferably, the beam path runs more than 3 mm above the door sill so that the dirt particles lying on the door sill cannot interrupt the beam path. The horizontal beam path allows the distance to the horizontal door sill to be kept constant over the width of the door sill. The unmonitored region of the door opening below the light beam is therefore vanishingly small. For this purpose, the retroreflective surface on the second door jamb preferably extends down to the door sill.

The second monitoring unit is preferably mounted on an upper end of the second door jamb. The second monitoring unit is preferably still within the first region of the door frame, i.e., where the first retroreflective surface is used for monitoring by the first monitoring unit. For this purpose, the first retroreflective surface can be mounted around the second monitoring unit or next to the second monitoring unit. The first retroreflective surface can also have a gap at the location of the second monitoring unit. Likewise, the second retroreflective surface can be mounted around the first monitoring unit or next to the first monitoring unit. In particular, it is advantageous if the first monitoring region and the second monitoring region overlap. In addition, the second monitoring unit is mounted at least 1.6 m or more above the door sill. This is advantageous, since, in some markets, regulations prescribe monitoring the door opening up to a height of at least 1.6 m above the door sill. The regions above this can be monitored.

The monitoring region monitored by each of the monitoring units is in each case limited to beam paths for whose angle the light source emits light, the beam path hits a retroreflective surface, and the light sensor is suitable for detecting the reflected light beam. The monitoring regions of all monitoring units are substantially triangular. The triangle is formed from a first corner at which the monitoring unit is located. The edge of the triangle opposite this point is formed by those points of the retroreflective surface which are illuminated by the light source, and which reflect the light of the light source back to the light sensor in such a way that the light sensor can measure the intensity of the light for this angle, and whose measurement values are used in the evaluation.

The region of the door opening below the second monitoring unit is divided into a first and a second right-angled, triangular monitoring region, wherein the lower first monitoring region is monitored by the first monitoring unit, and the upper second monitoring region is monitored by the second monitoring unit. The boundary region between these two monitoring regions is preferably monitored by both. The second monitoring unit can also partially monitor the region of the door opening over the second monitoring unit. The first monitoring unit thereby substantially monitors the first monitoring region between the first monitoring device, the second monitoring device, and a point at the lower end of the second door jamb. The second monitoring unit thereby substantially monitors the second monitoring region between the second monitoring device, the first monitoring device, and a point on the first door jamb which is lower, equal to, or higher than the second monitoring device. Preferably, however, this point is the same distance above the door sill as the second monitoring unit. The first and the second monitoring regions can therefore both be shaped like rectangular triangles, which complement one another to form a rectangle. The rectangle corresponds at least to a portion of the door opening.

Furthermore, it is advantageous to arrange the second monitoring unit only a few millimeters below the door lintel-preferably less than 10 mm.

The door opening is completely monitored by such an arrangement. The first monitoring unit substantially monitors the first monitoring region between the first monitoring device, the lower corner, opposite the first monitoring device, of the door opening, and the second monitoring device. The second monitoring unit thereby substantially monitors the second monitoring region between the second monitoring device, the upper corner, opposite the second monitoring device, of the door opening, and the first monitoring device.

Preferably, the retroreflective surface extends over the entire height of the first and second door jambs, and preferably runs around the monitoring units or next to them.

In this embodiment, at least one or each of the monitoring units preferably has a possible opening angle of the beam fan of at least 60°—preferably 90°. This means that even very narrow doors can be monitored from the top and bottom corners.

According to a second alternative and preferred embodiment, a first monitoring unit is mounted on a lower end of a first door jamb oriented in such a way as to allow a light beam to pass horizontally over the door sill. A second monitoring unit is mounted on a central region of a second door jamb opposite the first door jamb. A third monitoring unit is mounted on an upper end of the first door jamb.

In this arrangement with three monitoring units, the first monitoring unit, also as described above, is therefore mounted such that the first monitoring unit is designed to measure at least one light beam whose beam path runs horizontally-preferably only a few millimeters above the door sill. This has the same advantages as described above with regard to the first alternative embodiment.

The second monitoring unit is mounted centrally on the second door jamb. For this purpose, it is preferably mounted so that the center or bisecting beam path in the monitoring region is horizontal. That is to say, of the preferably at least 90° monitoring region of the second monitoring unit, an upper monitoring region preferably comprising at least 45° is located above a horizontal plane at the level of the second sensor, and a lower monitoring region preferably comprising at least 45° is located below the horizontal plane at the level of the second sensor.

Preferably, the third monitoring unit is mounted only a few millimeters below the door lintel-preferably less than 10 mm.

The first monitoring unit substantially monitors the first monitoring region, which is substantially triangular, between the first monitoring device, the lower corner, opposite the first monitoring device, of the door opening, and the second monitoring device.

The second monitoring unit therefore substantially monitors the second monitoring region, which is substantially triangular, between the second monitoring device, the first monitoring device, and the third monitoring device.

The third monitoring unit therefore substantially monitors the third monitoring region, which is substantially triangular, between the third monitoring device, the upper corner, opposite the third monitoring device, of the door opening, and the second monitoring device.

Preferably, at least one or each of the monitoring units has an opening angle of the beam fan of less than 90°, i.e., for example, 91° to 120°. In particular, the second monitoring unit is installed in such a way that a central beam of the light beam fan runs substantially horizontally. The light beam fan of the second monitoring unit therefore radiates approximately at a 45° angle downwards, i.e., substantially to the first monitoring unit, and at a 45° angle upwards, i.e., substantially to the third monitoring unit. Monitoring units of the same design can also be installed as first and third monitoring units. Although the emitted light beam fan then, for example, partially strikes the door sill for the first monitoring unit, the other part of the light beam fan covers the monitoring region up to the second monitoring device. A uniform model of the monitoring unit can thereby be used. This saves upon costs and simplifies the storage of the monitoring units.

The monitoring unit can be designed such that a setting option exists for restricting the region to be monitored. The first monitoring region of the first monitoring unit can therefore be limited, for example, in such a way that the door threshold is excluded from the evaluation and cannot be detected as an obstacle. The same applies analogously to all other monitoring devices and their regions that are not to be monitored, such as door sill, door lintel, or gaps in the retroreflective surface. Such a restriction of the monitoring region preferably takes place in the evaluation. The evaluation can, for example, specifically analyze only the angle-resolved intensities for the angular range to be monitored. This means that the other angular ranges are not compared with a threshold intensity at all. Alternatively, for the angular ranges that are not to be monitored, the threshold intensity can be lowered to a minimum value, so that the measurement value always lies above the threshold intensity. Preferably, the setting of the angular ranges to be monitored or to be excluded is transmitted electronically via a data connection to the particular monitoring unit.

Further advantages, features, and details of the invention can be found in the following description of embodiments and with reference to the drawings, in which like or functionally like elements are provided with identical reference signs. The drawings are merely schematic and are not to scale.

### DESCRIPTION OF THE DRAWINGS

In the figures:

FIG. 1 shows a door system in the open state.

FIG. 2 shows the functional principle of the monitoring unit.

FIG. 3 shows an output of the angle-resolved intensities for the situation in FIG. 2.

FIG. 4 shows a door with a plurality of installed monitoring units.

### DETAILED DESCRIPTION

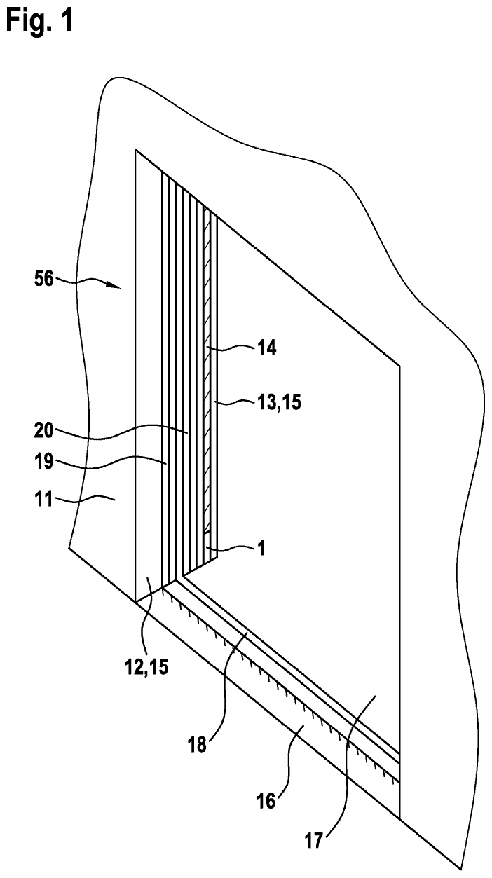

FIG. 1 shows a door system 56 in a view from the floor. In this case, the door system is embedded in a wall 11. The floor door 19 and the elevator car door 20 are open in a door frame 15. A gap 18 extends between the floor-side door sill 16 and the car-side door sill 17. This gap 18 ensures that the car can move upwards and downwards without contact in the elevator shaft.

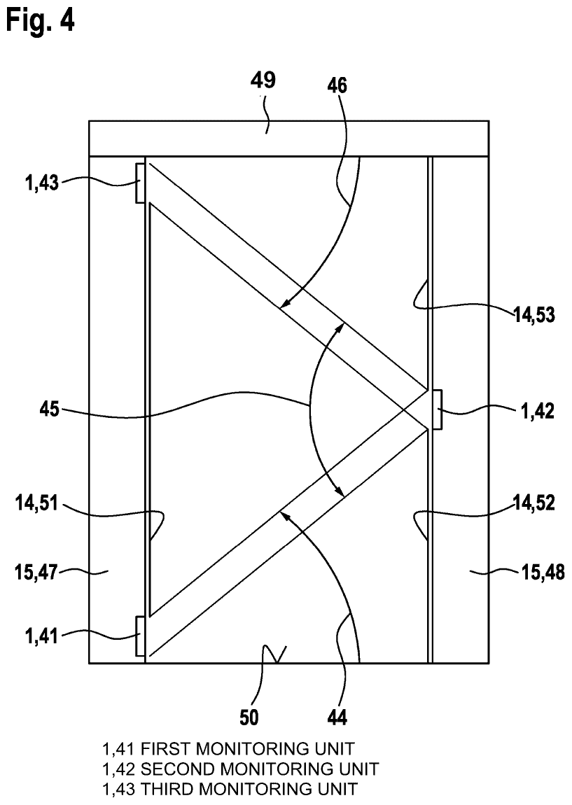

A first monitoring unit 1 (1, 41 in FIG. 4) is mounted at the car-side door frame 13, 15 in that it is embedded in the car-side door frame 13, 15. The open doors 19, 20, the floor-side door frame 12, 15, and the car-side door frames 13, 15 are thereby aligned. They therefore form a flat surface.

The car-side door frame 13, 15 has a retroreflective surface 14. The retroreflective surface 14 visible in FIG. 1 serves as a retroreflective surface 14 for a second monitoring unit on the right-hand, not shown, car-side door jamb. The first monitoring unit 1, 41 is mounted at the left bottom in the door opening; the first retroreflective surface for the first monitoring unit 1, 41 is mounted on the right door frame. FIG. 1 does not show the first retroreflective surface.

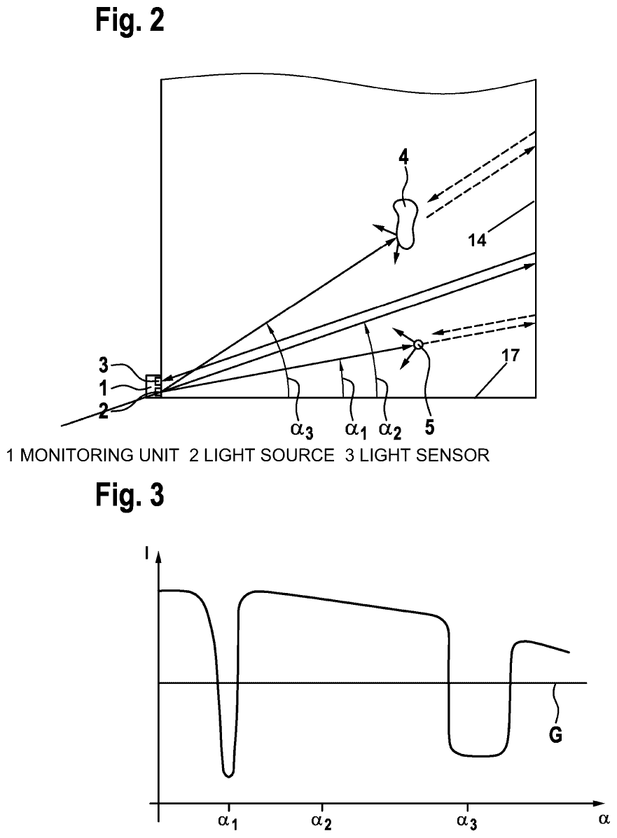

FIG. 2 shows the functional principle of a monitoring unit 1. The monitoring unit 1 comprises a light source 2 and a light sensor 3. The light source 2 emits light. The light thereby illuminates at least the retroreflective surface 14 mounted on the opposite side of the door opening. For this purpose, the light source 2 emits light. A lowest light beam of the monitoring region measured by the light sensor 3 and evaluated by the monitoring unit 1 runs horizontally, just above the door sill 17.

If a light beam does not strike an obstacle, as is the case for example for the light beam at the angle α₂, the retroreflective layer basically reflects the light in the exact direction from which the light beam strikes the retroreflective surface 14. In so doing, the light beam widens slightly so that it is not only reflected precisely back to the light source 2, but also strikes the light sensor 3 located directly next to the light source. Without an obstacle, i.e., when the light beam is not interrupted by an obstacle, such as a hand or luggage, the light sensor 3 measures a high angle-resolved intensity for a certain angle within the monitoring region. In particular, the angle-resolved intensity is higher than a threshold intensity G (see FIG. 3).

If the light beam strikes an obstacle, such as, for example, at angle α₁ or α₃, the light is therefore scattered or absorbed by the obstacle. The obstacle therefore prevents the light from reaching the retroreflective surface 14 and being reflected back to the light sensor 3. In other words, the light beam that is scattered or absorbed due to the obstacle no longer runs along the beam path shown in a dashed line, which it would follow without the obstacle. This means that a low angle-resolved intensity is measured for those angles in which an obstacle blocks the light. In particular, the measured angle-resolved intensity is smaller than the threshold intensity G.

FIG. 3 shows an example of a measurement of the light sensor 3 for the situation as shown in FIG. 2. For the angle α₁, a first small obstacle 5 (see FIG. 2) scatters or absorbs the light. Therefore, a clear reduction in the measured angle-resolved intensity for the angle α₁ is discernible. The measured angle-resolved intensity is smaller than the defined threshold intensity G. The measured angular-resolved intensity without obstacles can also vary slightly-for example, because the intensity of the reflected light decreases slightly from the first monitoring unit with increasing distance from the retroreflective surface. However, the threshold intensity G is selected such that the intensity without an obstacle remains above the threshold intensity G for all angles. Alternatively, the threshold intensity can be defined separately for each individual beam path, e.g., as a function of the distance between the first monitoring unit and the retroreflective surface, so that a threshold intensity optimal for the particular beam path is defined for each angle.

For the second larger obstacle 4 (see FIG. 2), the light sensor 3 measures when the angle-resolved intensity falls below the threshold intensity for a plurality of beam paths adjacent to one another in the monitoring region. The number of angle-dependent measured intensities that consecutively fall below the threshold intensity is a measure of the size of the obstacle.

FIG. 4 shows a first monitoring unit 1, 41 which is attached at the bottom left to a first door jamb 15, 47 of the door frame 15. This first monitoring unit 1, 41 covers a first monitoring region 44 from the door sill 50 up to the second monitoring unit 1, 42. The second monitoring unit 1, 42 covers a monitoring region from the first monitoring unit 1, 41 up to the third monitoring unit 1, 43 and is mounted on the second door jamb 15, 48. All monitoring units or devices 1 are recessed in the door frame 15.

The second monitoring region 45 covers an angle of approximately 90°. The monitoring regions 44, 45, 46 overlap. The entire door opening can thereby be monitored.

The first monitoring region 44 and the third monitoring region 46 each cover an angle of approximately 45°, although the first and the third monitoring units 1, 41, 43, if they were used at the location of the second monitoring unit, for example, could cover a monitoring region of 90°. The restriction to 45° is therefore only justified because the monitoring region is preferably restricted in the evaluation. The hardware of the first monitoring device and the second monitoring device therefore preferably does not differ.

The first monitoring device 1, 41 substantially measures the light that is reflected back by the first retroreflective surface 14, 52. To a small extent, the light at the lowermost end of the third retroreflective surface 14, 53 is also reflected to the first monitoring unit 1, 41 and measured there. This is a consequence of the overlap of the first monitoring region with the second monitoring region. The third monitoring device 1, 43 substantially measures the light that is reflected back by the third retroreflective surface 14, 53. To a small extent, the light at the uppermost end of the first retroreflective surface 14, 52 is also reflected to the third monitoring unit, and measured there. This is a consequence of the overlap of the third monitoring region with the second monitoring region. The second monitoring device 1, 42 substantially measures the light that is reflected back by the second retroreflective surface 14, 51. This runs substantially over the entire height of the first door jamb 15, 47. It can also run next to the monitoring units or around them so that they reach right up to the door sill 50 and right up to the door lintel 49.

The light which strikes the door sill 50 or the door lintel 49 of the door frame 15 is not radiated back to the particular monitoring unit 1, and therefore leads to very small measured values for the angle-resolved intensity from these directions. These would therefore be permanently below the threshold intensity. The particular monitoring unit is therefore set such that the region to be monitored is limited. For example, the first monitoring region of the first monitoring unit is therefore limited in such a way that the beam paths which are scattered at the door sill are excluded from the evaluation, and therefore the door threshold is not detected as an obstacle.

Finally, it should be noted that terms such as “having,” “comprising,” etc., do not preclude other elements or steps, and terms such as “a” or “one” do not preclude a plurality. Furthermore, it should be noted that features or steps which have been described with reference to one of the above exemplary embodiments may also be used in combination with other features or steps of other exemplary embodiments described above. The term “reflect” in association with the retroreflective surface means a retroreflective reflection, such as is also rarely used with the rather uncommon term “retroreflective.”

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A door system for an elevator system, the door system comprising:
a door frame framing a door opening, the door frame including a first door jamb and a first retroreflective surface in a first region of the door frame;
a first monitoring unit mounted on the door frame and monitoring a first monitoring region of the door opening;
wherein the first monitoring unit has a light source that illuminates the first retroreflective surface with light beams;
wherein the first monitoring unit has a light sensor that measures an angle-resolved intensity of the light beams that are reflected by the first retroreflective surface; and
wherein the first monitoring unit determines an output value based upon the angle-resolved intensity, the first monitoring unit monitoring when the angle-resolved intensity falls below a predetermined threshold intensity for at least one angle or angular range, and the output value including whether the angle-resolved intensity lies below the threshold intensity for the at least one angle or angular range.

15. The door system according to claim 14 characterized in that a height of the first region of the door frame extends over at least 20% of a height of the door opening.

16. The door system according to claim 14 wherein the light source emits infrared light, the first retroreflective surface reflects the infrared light, and the light sensor measures the angle-resolved intensity of the reflected infrared light.

17. The door system according to claim 14 wherein the light source emits the light amplitude-modulated at a predetermined frequency, the first monitoring unit includes an evaluation unit that demodulates the angle-resolved intensities, and the first monitoring unit determines the output value based upon the demodulated, angle-resolved intensities.

18. The door system according to claim 14 wherein the first retroreflective surface is applied to the door frame as a spray layer, a coating or a retrotape.

19. The door system according to claim 14 wherein the first monitoring unit is embedded in the door frame.

20. The door system according to claim 14 wherein the door frame is a car-side door frame.

21. The door system according to claim 14 including a second monitoring unit mounted on the door frame and monitoring a second monitoring region of the door opening.

22. The door system according to claim 21 wherein the first monitoring region overlaps with the second monitoring region.

23. The door system according to claim 21 including a third monitoring unit mounted on the door frame and monitoring a third monitoring region of the door opening.

24. The door system according to claim 23 wherein the second monitoring region overlaps with the third monitoring region.

25. The door system according to claim 21 wherein the a first monitoring unit is mounted on a lower end of the first door jamb and is oriented to pass a light beam horizontally above a door sill of the door opening and the second monitoring unit is mounted at an upper end of the first door jamb or on an opposite, second door jamb of the door frame.

26. The door system according to claim 21 wherein the first monitoring unit is mounted on a lower end of the first door jamb and is oriented to pass a light beam horizontally above a door sill of the door opening, the second monitoring unit is mounted on a central region of a second door jamb opposite the first door jamb, and including a third monitoring unit mounted on an upper end of the first door jamb and monitoring a third monitoring region of the door opening.
